(19) United States
(12) Patent Application Publication
(10) Pub. No.: US 2025/0162163 A1
(43) Pub. Date: May 22, 2025

(54) REALISTIC EYEBALL AND ROBOT

(71) Applicant: 3ASCREEN CORPORATION, New Taipei City (TW)

(72) Inventors: YI-Hau SHIAU, New Taipei City (TW); Shao-Lun HUANG, New Taipei City (TW); Chao-Chi CHUNG, New Taipei City (TW)

(21) Appl. No.: 18/637,845

(22) Filed: Apr. 17, 2024

(30) Foreign Application Priority Data
Nov. 17, 2023 (TW) 112144587

(51) Int. Cl. B25J 11/00

(52) U.S. Cl. CPC B25J 11/0015

(57) ABSTRACT

A realistic eyeball and a robot. The realistic eyeball includes a display unit, a convex lens unit and a sensing unit. The display unit has a display surface, which includes a pupil area and an iris area surrounding the pupil area. The pupil area or the iris area has at least one penetration region. The convex lens unit is disposed on the display surface and covers the pupil area and the iris area. The sensing unit is disposed at the display unit, and is located corresponding to the position of the at least one penetration region. The pupil area and the iris area have different patterns and colors according to different simulated animals.

### CROSS REFERENCE TO RELATED APPLICATIONS

This Non-provisional application claims priority under 35 U.S.C. § 119 (a) on Patent Application No(s). 112144587 filed in Taiwan, Republic of China on Nov. 17, 2023, the entire contents of which are hereby incorporated by reference.

### BACKGROUND

### Technology Field

The present disclosure relates to an artificial eyeball and a robot, and in particular, to a realistic eyeball and a robot with the realistic eyeball.

### Description of Related Art

Due to the intensive development of various robot manufacturers, in addition to basic mobile functions, service robots have also developed many types of functions, such as disinfection robots born in response to the needs of the epidemic (e.g. COVID-19), transport robots to assist in carrying heavy objects, chat robots that can chat with users, etc. The service robots are ready to integrate into our lives, taking on boring and repetitive tasks for people. The robots do not need to rest and can be on duty 24 hours per day, which not only reduces business costs, but also allows people to focus more on creating service values.

In addition, the number of newborns is declining year by year, and instead, more and more people are keeping pets. According to statistics, the number of new pet registrations has exceeded the number of newborns in recent years. The benefits of keeping pets are numerous, such as reducing stress and anxiety. Moreover, taking pets out for a walk can also increase the amount of exercise. Some studies have pointed out that keeping pets can reduce depression and loneliness. However, the life spans of most pets are shorter than that of humans. When a pet passes away, it may take the owner some time to recover from the pain.

The eyes of conventional service robots or pet robots are mostly just decorations. In some conventional service robots or pet robots, the displayed eye is a simple eye pattern (e.g. a black dot in a circle to represent the pupil). In some other conventional service robots or pet robots, a camera is installed in the eye to obtain images, which is a quite simple function. The eyes of conventional service robots or pet robots cannot realistically resemble the eyes of humans or different animals (i.e., have patterns and/or color changes corresponding to individuals or specific animals), and cannot express emotions.

### SUMMARY

An objective of the present disclosure is to provide a realistic eyeball and a robot with the realistic eyeball that can simulate patterns and/or color changes of real eye.

To achieve the above, a realistic eyeball of this disclosure includes a display unit, a convex lens unit and a sensing unit. The display unit has a display surface, and the display surface includes a pupil area and an iris area surrounding the pupil area. At least one of the pupil area and the iris area has at least one penetration region. The convex lens unit is disposed on the display surface and covers the pupil area and the iris area. The sensing unit is disposed at the display unit and located corresponding to a position of the at least one penetration region. The pupil area and the iris area have different patterns and colors according to different simulated animals.

In one embodiment, the display unit is an LED display device, an OLED display device, an LCD device, or an e-paper display device.

In one embodiment, the realistic eyeball further includes an adhesive layer, which is disposed between the display surface and the convex lens unit.

In one embodiment, the penetration region is configured with a through hole, the sensing unit is arranged in the through hole, and a top surface of the sensing unit faces an opening of the through hole.

In one embodiment, the penetration region is configured with a plurality of pixels, the display unit further includes a back surface opposite to the display surface, the sensing unit is disposed on the back surface, and a top surface of the sensing unit faces the penetration region.

In one embodiment, a part of each of the pixels in the penetration region is a transparent area, and the transparent areas define the penetration region.

In one embodiment, the penetration region is a transparent area and is configured without any pixel, the display unit further includes a back surface opposite to the display surface, the sensing unit is disposed on the back surface, and a top surface of the sensing unit faces the penetration region.

In one embodiment, the sensing unit includes a sensor, and the sensor comprises a visible-light sensor, an infrared sensor, or an ultrasonic sensor, or a combination thereof.

In one embodiment, the sensor includes a camera, a light detector, or a distance detector, or a combination thereof.

In one embodiment, the display unit includes a display substrate, and the display substrate has a plurality of pixels. When the sensing unit includes an infrared sensor, the display substrate is permeable by an infrared light.

In one embodiment, the realistic eyeball further includes a control unit electrically connected to the sensing unit and the display unit. The sensing unit includes a light sensor, the light sensor receives a light passing through the convex lens unit and the penetration region and outputs a sensing signal, and the control unit changes a dimension of the pupil area and a dimension of the iris area of the display unit based on the sensing signal.

In one embodiment, when the dimension of the pupil area decreases, the dimension of the iris area increases; and when the dimension of the pupil area increases, the dimension of the iris area decreases.

In one embodiment, at least one of the pupil area and the iris area has a plurality of the penetration regions, the sensing unit includes sensors of different types, and the sensors of different types are arranged in the penetration regions, respectively.

In one embodiment, the penetration regions are distributed in the pupil area and the iris area.

In one embodiment, the display surface further includes a sclera area surrounding the iris area, the convex lens unit further covers the sclera area, and each of the pupil area, the iris area and the sclera area displays one of the patterns and one of the colors.

In one embodiment, the realistic eyeball further includes a control circuit board electrically connected to the display unit and the sensing unit, the control circuit board includes a database, and the database stores a plurality of patterns and colors of the pupil area and the iris area.

In one embodiment, the realistic eyeball further includes a light-shielding layer disposed on the display surface and surrounding the sclera area.

In one embodiment, the realistic eyeball further includes a functional layer disposed on a surface of the convex lens unit away from the display unit.

In one embodiment, the realistic eyeball further includes a light-shielding sheet, the pupil area of the display unit is a first through hole, the display unit further includes a back surface opposite to the display surface, and the light-shielding sheet is disposed on the back surface and has a second through hole corresponding to the first through hole. The dimension of the second through hole is less than the dimension of the first through hole, and the sensing unit is disposed in the first through hole via the second through hole.

In one embodiment, the realistic eyeball further includes a sphere body having a plane, the convex lens unit, the display unit and the light-shielding sheet are arranged on the plane, and the sphere body has a sclera pattern located at the periphery of the plane.

To achieve the above, a robot of this disclosure includes a head portion and the above-mentioned realistic eyeball, and the realistic eyeball is disposed on the head portion.

In one embodiment, the robot is a service robot or a pet robot.

In one embodiment, the robot controls the display unit to flash and/or to display a code based on a scenario.

As mentioned above, in the realistic eyeball and the robot with the realistic eyeball of this disclosure, the display surface includes a pupil area and an iris area surrounding the pupil area, the pupil area or the iris area has at least one penetration region, the convex lens unit is disposed on the display surface and covers the pupil area and the iris area, the sensing unit is disposed at the display unit and located corresponding to the penetration region, and the pupil area and the iris area have different patterns and colors according to different simulated animals. Based on this design, the realistic eyeball can simulate the patterns and/or color changes presented by the eyes of different human races or animals. In addition, the realistic eyeball of the present disclosure can realistically resemble the eyes of humans or any of other animals, thereby presenting the eyes with patterns and/or color changes that are unique to individual or specific animal, and can also express emotions through the displayed patterns.

Moreover, in one embodiment, the sensing unit may include a camera, which can receive the external light passing through the convex lens unit and the penetration region, and then see (detect) the object in front of the realistic eyeball, so that the robot can perform corresponding actions accordingly. In another embodiment, the sensing unit may include a light detector, and the light detector may detect the light passing through the convex lens unit and the penetration region. Then, the display unit can change the dimensions of the pupil area and the iris area. In another embodiment, the sensing unit may include a distance detector, and the distance detector may detect the distance between the realistic eyeball (robot) and an object, thereby adjusting the distance between the object and the realistic eyeball according to the detected distance.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1A is a perspective schematic diagram of a realistic eyeball according to an embodiment of this disclosure;

FIG. 1B is an exploded view of the realistic eyeball of FIG. 1A;

FIG. 1C is a top view of the realistic eyeball of FIG. 1A;

FIG. 1D is a perspective sectional view of the realistic eyeball of FIG. 1A;

FIG. 1E is a schematic diagram showing the relation between the display substrate of the display unit and the sensing unit in the realistic eyeball of FIG. 1D;

FIGS. 2, 3A to 3D, 4A to 4B, 5, 6 and 7A to 7B are schematic diagrams showing the realistic eyeballs according to different embodiments of this disclosure; and

FIGS. 8 to 10 are schematic diagrams showing a robot according to different embodiments of this disclosure.

### DETAILED DESCRIPTION OF THE DISCLOSURE

The present disclosure will be apparent from the following detailed description, which proceeds with reference to the accompanying drawings, wherein the same references relate to the same elements.

The realistic eyeball of this disclosure can also be called as an artificial intelligence (AI) eyeball, which can simulate the patterns and/or color changes presented by eyes of human or animals. In addition, the simulated eyeballs in this article can realistically resemble the eyes of humans or different animals, can have patterns and/or color changes that are unique to individuals or specific animals, and can also express emotions through the patterns displayed by the eyeballs. The components appearing in the following embodiments are only used to illustrate their relative relationships and do not represent the proportions or sizes of the actual components.

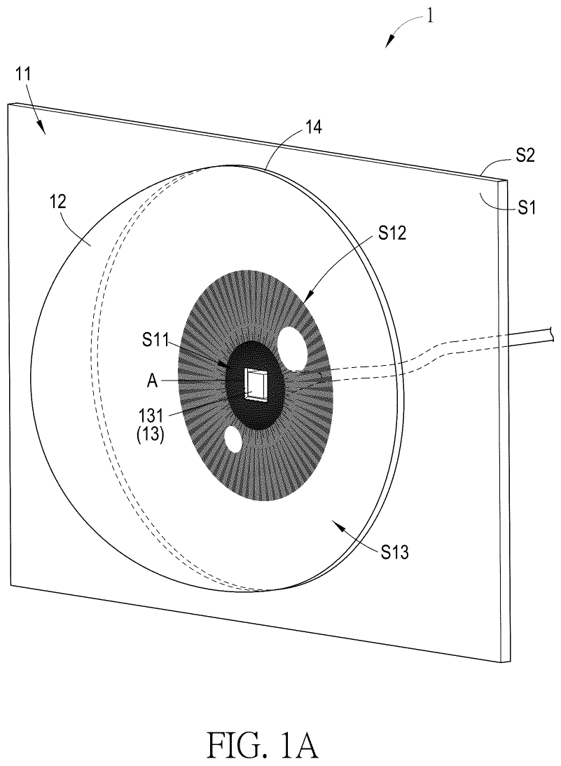

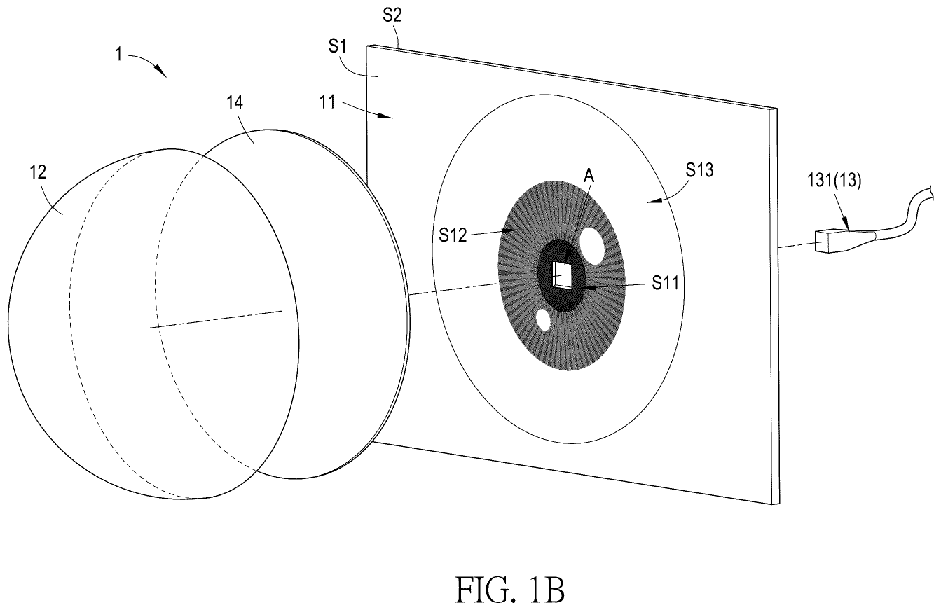

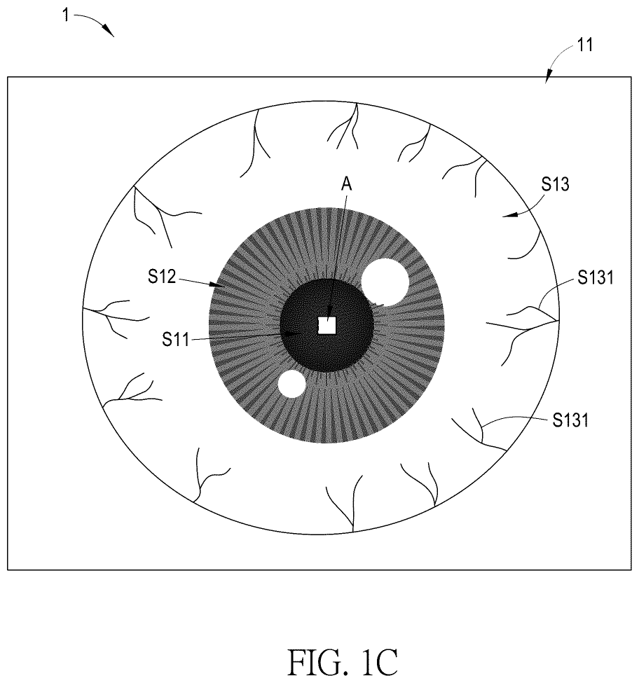

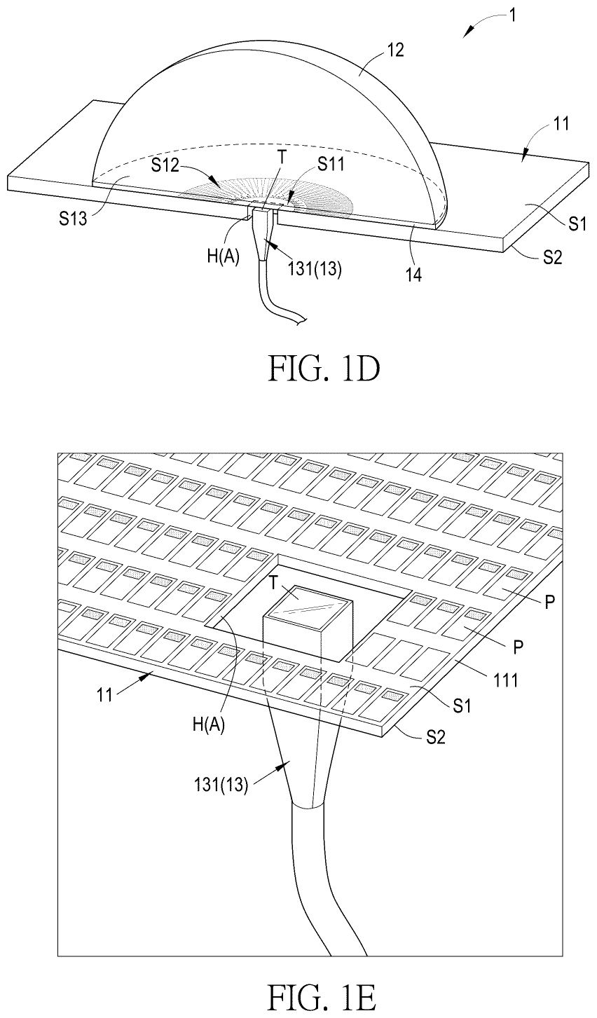

FIG. 1A is a perspective schematic diagram of a realistic eyeball 1 according to an embodiment of this disclosure, FIG. 1B is an exploded view of the realistic eyeball 1, FIG. 1C is a top view of the realistic eyeball 1, FIG. 1D is a perspective sectional view of the realistic eyeball 1, and FIG. 1E is a schematic diagram showing the relation between the display substrate 111 of the display unit 11 and the sensing unit 13 in the realistic eyeball 1 of FIG. 1D. To be noted, FIG. 1C does not show the convex lens unit 12 of the realistic eyeball 1.

Referring to FIGS. 1A to 1E, the realistic eyeball 1 includes a display unit 11, a convex lens unit 12, and a sensing unit 13. In addition, the realistic eyeball 1 of this embodiment can further include an adhesive layer 14.

The display unit 11 has a display surface S1, and the display surface S1 includes a pupil area S11 and an iris area S12 surrounding the pupil area S11. The pupil area S11 and the iris area S12 have different patterns and colors according to different simulated animals. The pupil area S11 or the iris area S12 has at least one penetration region A, which is a light-permeable region (including visible light or invisible light). In practice, the penetration region A can be a physical hole or a non-physical hole. In this embodiment, the penetration region A can be disposed in the pupil area S11 or in the iris area S12, or it can be distributed in the pupil area S11 and the iris area S12. This disclosure is not limited thereto. The shape of the penetration region A can be a circle, a quadrilateral (e.g. square, rectangle, rhombus, parallelogram, or trapezoid), an ellipse or any of other shapes. In this embodiment, the shape of the penetration region A is, for example, a square.

In addition, the display surface S1 of this embodiment may further include a sclera area S13, and the sclera area S13 surrounds the iris area S12. In this embodiment, the pupil area S11, the iris area S12 and the sclera area S13 together form a circular display area, and each of the pupil area S11, the iris area S12 and the sclera area S13 can display a corresponding pattern, thereby presenting the pattern and color corresponding to the simulated animal. Specifically, the pupil area S11 is used to display the pupil pattern of the simulated eye, wherein the pupil area S11 can be black or brown and the shape thereof is not limited. The shape, pattern and/or color of the displayed pupil can be different for simulating the eyes of different human races or animals. The iris area S12 is used to display the pattern of the iris. The shape, pattern and/or color of the displayed iris can be different for simulating the eyes of different human races or animals. The sclera area S13 is used to display the pattern of the sclera. The shape, pattern and/or color of the displayed sclera can be different for simulating the eyes of different human races or animals. For example, as shown in FIG. 1C, the sclera area S13 can simulate the red lines S131 (e.g. blood vessels) present in the white portion of human eye. Therefore, if the service robot works for a long time, the sclera area S13 can display the red lines S131, thereby simulating the real situation of the human eye that has bloodshot due to long-term working.

In this embodiment, the shape of the display unit 11 is, for example, a rectangular shape, but this disclosure is not limited thereto. Preferably, in order to make the (artificial) eyelids close and open more like the blinking conditions of real eyes, the circular display unit 11 is more suitable for simulating real eyeballs. That is, the display unit 11 only has the pupil area S11, the iris area S12 and the sclera area S13. In one embodiment, the rectangular display unit 11 of this embodiment can be replaced by a circular display unit. This circular display unit only displays the pupil area S11, the iris area S12, and the sclera area S13.

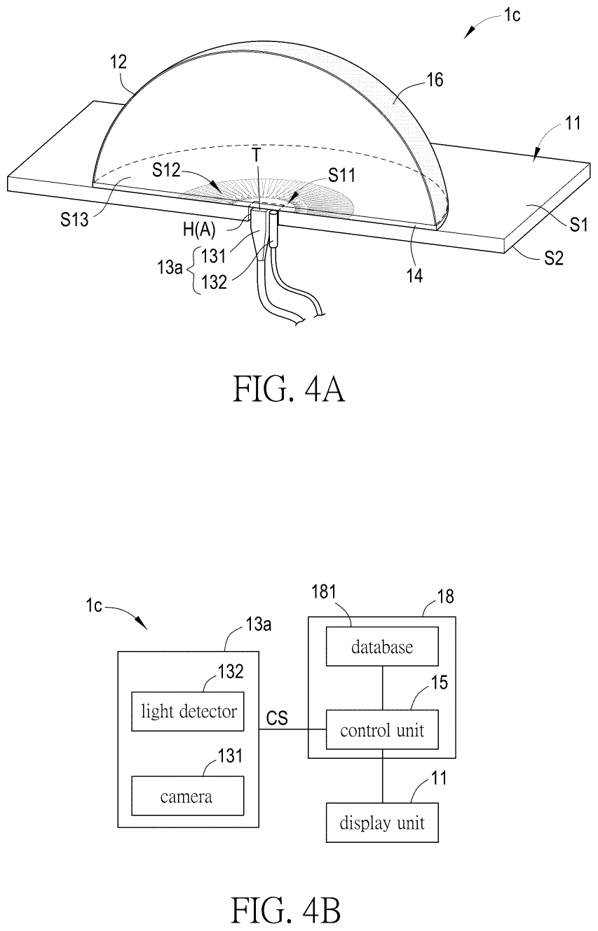

In one embodiment, the display unit 11 can be electrically connected to the main control board (e.g. the control circuit board 18 shown in FIG. 4B) via, for example, a flexible circuit board (e.g. COF), so that the display unit 11 can be controlled to display the pattern and/or the color change of the simulated eyes through the main control board. In one embodiment, the display unit 11 may be an LED (light-emitting diode) display device, an OLED (organic light-emitting diode) display device, an LCD (liquid crystal display) device, or an e-paper display (EPD) device. The LED display device may include a Mini LED display device or a Micro LED (μLED) display device, but this disclosure is not limited thereto. In one embodiment, the display unit 11 can be a self-luminous, transmissive or reflective display device. In particular, the display unit 11 is preferably a bistable reflective display device because the bistable reflective display device does not consume power when the image is not renewed. This is similar to that the iris of a real human eye remains in the same state. In one embodiment, mass transfer technology can be used to mass transfer a plurality of μLEDs onto a planar substrate (e.g. a PI substrate) to form the display unit 11.

The convex lens unit 12 is disposed on the display surface S1 and covers the pupil area S11 and the iris area S12. In this embodiment, the convex lens unit 12 further covers the sclera area S13. The convex lens unit 12 is made of transparent (or light-permeable) material. In general, it is necessary to prepare different types of convex lens units 12 for simulating the eyes of human or other animals. A more suitable convex lens unit 12 is an elastic single-sided convex lens, and the curvature of the single-sided convex lens can be manufactured according to the simulated eyes of human or different animals. The material of the convex lens unit 12 is, for example but not limited to, silica gel (including, for example, silicone methyl material or silicon phenyl material, etc.). In one embodiment, the convex lens unit 12 may be made of glass or polyimide (PI).

The sensing unit 13 is disposed at the display unit 11 and located corresponding to a position of the at least one penetration region A. As shown in FIG. 1D, in this embodiment, the pupil area S11 has a penetration region A, and the penetration region A is provided with a through hole H penetrating through the display unit 11. For example, the extending direction of the through hole H is perpendicular to the display surface S1. In addition, as shown in FIG. 1E, the display unit 11 of this embodiment is, for example, a micro LED (μLED) display device, which may include a display substrate 111. The display substrate 111 can be, for example but not limited to, a TFT (thin-film transistor) substrate. To be noted, the display unit 11 may also include any of other layers and/or substrates, which is not limited in this disclosure. The display substrate 111 has a plurality of pixels P (a plurality of μLEDs) arranged in a two-dimensional array. Since the penetration region A is a through hole H, the penetration region A is not configured with any pixel P. In addition, the sensing unit 13 may include a sensor. For example, the sensor may include a visible light sensor, an infrared sensor, an ultrasonic sensor, or a combination thereof. In another case, the sensor may include a camera, a light detector, a distance detector, or a combination thereof. Specifically, the camera can be a visible light camera, an infrared camera, or an ultrasonic camera, the light detector can be a visible light detector, an infrared light detector, or an ultrasonic detector, and the distance detector can be a visible light distance detector, an infrared distance detector, or an ultrasonic distance detector. The configuration of the sensing unit 13 is optionally selected at least from the above examples depending on actual usage. In one embodiment, if the sensor is an ultrasonic sensor, the sensing unit 13 may include a plurality of ultrasonic sensors. In this case, since the sensitivity of the ultrasonic sensor is easily inaccurate while the air (bubbles) exists in the detecting direction, the display unit is preferably selected from the above-mentioned display devices other than the LCD display device. In other words, all layers of the preferred display device need to be tightly attached to one another, so that there are no (or almost no) air bubbles existing in front of the ultrasonic sensor (camera).

In this embodiment, the sensing unit 13 includes a sensor, which is a camera 131 for example. In one embodiment, the camera 131 is a visible light camera (which can obtain color images), an infrared (IR) camera (which can obtain black and white images), or an ultrasonic camera. In this case, the camera 131 is, for example, a visible light camera. The camera 131 (sensor) is a micro camera and is disposed in the through hole H, and a top surface T of the camera 131 (sensing unit 13) faces the opening of the through hole H. In order to ensure the optical sensing sensitivity of the visible light camera 131 and ensure that the captured images are not distorted, the refractive index of each layer in front of the top surface T of the camera 131, including the display substrate 111, the adhesive layer 14 and the convex lens unit 12, must be as consistent as possible (the same). In one embodiment, the sensing unit 13 can be fixed in the through hole H using, for example, a fixing member, glue, or any of other fixing methods, wherein the fixing methods are not limited. In one embodiment, the dimension of the penetration region A may be equal to or slightly larger than the dimension of the sensing unit 13, but smaller than the dimension of the pupil area S11 or the iris area S12. In one embodiment, the dimension of the camera 131 is, for example, about 0.65 mm.

The adhesive layer 14 is provided between display surface S1 and convex lens unit 12. The adhesive layer 14 is used to adhere the convex lens unit 12 to the display unit 11. In this embodiment, the adhesive layer 14 can include, for example but not limited to, optical clear adhesive (OCA), optical clear resin (OCR), or any of other transparent adhesive materials.

As mentioned above, in the realistic eyeball 1 of this embodiment, the pupil area S11, the iris area S12 and sclera area S13 of the display unit 11 can respectively display corresponding patterns and/or color changes, and the pupil area S11, the iris area S12 and the sclera area S13 have different patterns and colors according to different simulated animals. In this embodiment, the patterns and/or color changes to be displayed (simulated) in the pupil area S11, the iris area S12 and the sclera area S13 can be stored in the aforementioned main control board, and the main control board can control the pupil area S11, the iris area S12 and the sclera area S13 of the display unit 11 to respectively display the corresponding patterns and/or color changes, thereby simulating the patterns and/or color changes of the eyes of human or different animals. Furthermore, the pupil area S11, the iris area S12 and the sclera area S13 of the display unit 11 can also simulate the patterns and/or colors unique to an individual or a specific animal, thereby expressing a specific emotion, such as happiness or sadness. In addition, the camera 131 can receive the external light passing through the convex lens unit 12 and the penetration region A (the through hole H), and then see (detect) the object in front of the realistic eyeball 1 so as to perform corresponding actions accordingly.

FIGS. 2 to 7B are schematic diagrams showing the realistic eyeballs according to different embodiments of this disclosure

The component configurations and connections of the realistic eyeball 1a of this embodiment of FIG. 2 are mostly the same as those of the realistic eyeball 1 of the previous embodiment. Unlike the realistic eyeball 1 of the previous embodiment, the realistic eyeball 1a further includes a functional layer 16, which is disposed on a surface of the convex lens unit 12 away from the display unit 11. In this embodiment, the functional layer 16 is a light-permeable film or layer, such as, for example but not limited to, an anti-scratch film, an anti-glare film, an anti-reflection film, an anti-fingerprint film, or a waterproof and antifouling film, or any combination thereof. This disclosure is not limited thereto.

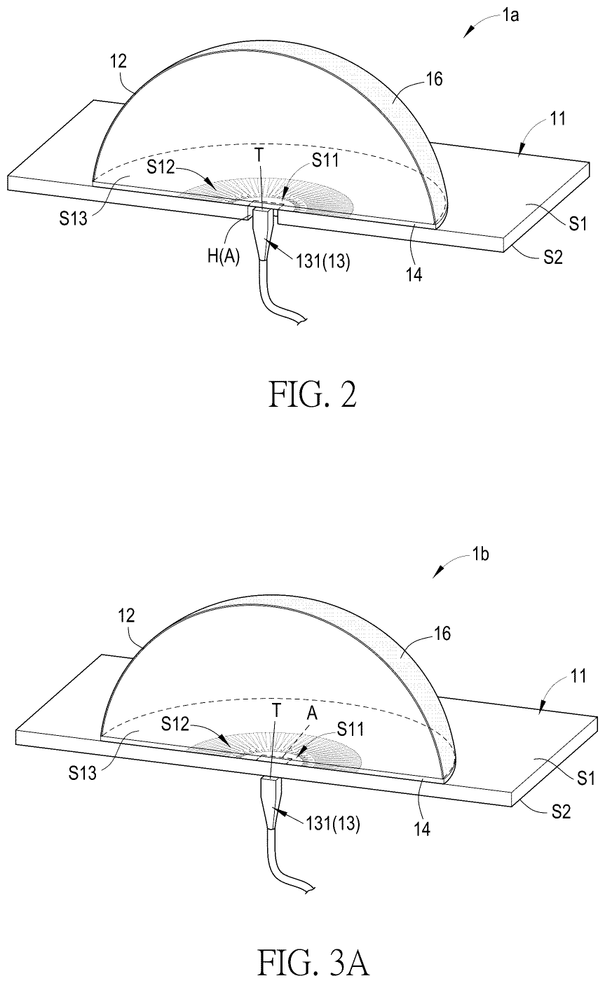

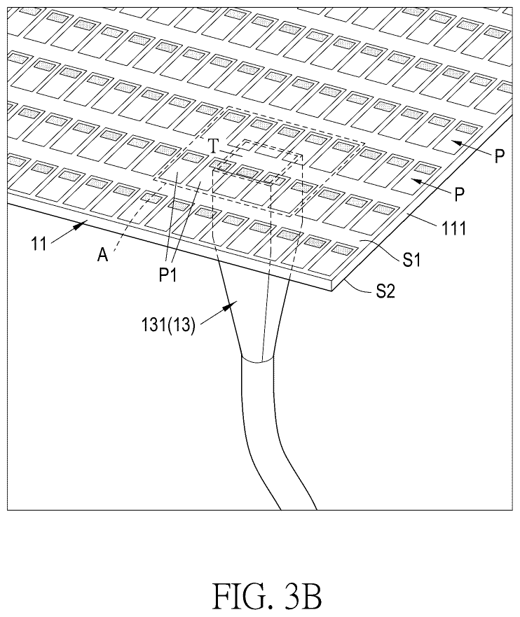

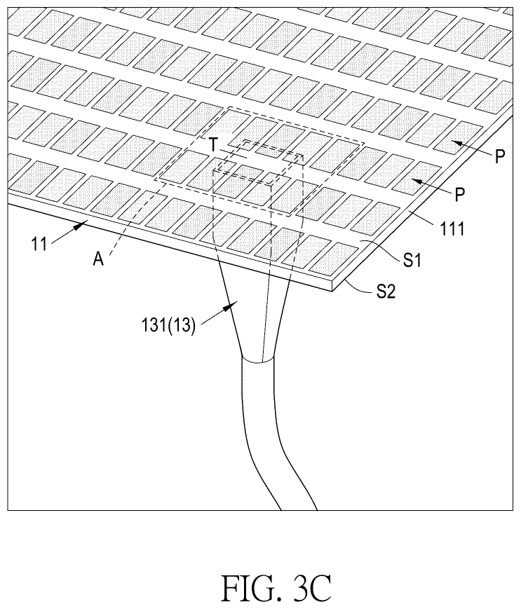

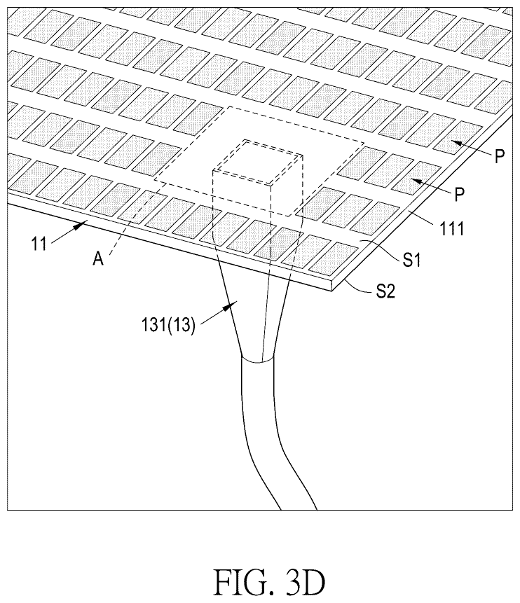

The component configurations and connections of the realistic eyeball 1b of this embodiment of FIGS. 3A and 3B are mostly the same as those of the realistic eyeball 1a of the previous embodiment. Unlike the realistic eyeball 1a of the previous embodiment, in the realistic eyeball 1b, the penetration region A is not a physical hole, but a solid area through which the light can pass. As shown in FIG. 3B, the penetration region A of this embodiment is provided with a plurality of pixels P, and the display unit 11 further has a back surface S2 opposite to the display surface S1. The sensing unit 13 (camera 131) is arranged (fixed) on the back surface S2, and the top surface T of the camera 131 (sensing unit 13) faces the penetration region A. Specifically, the penetration region A of the display unit 11 of this embodiment is provided with a plurality of specially designed pixels P, wherein a part of each pixel P in the penetration region A (transparent area P1) is specially designed to be transparent through which light can pass. These transparent areas P1 form the penetration region A. Therefore, the light passing through the transparent areas P1 can also enter the camera 131. In one embodiment, a part of each pixel P in the penetration region A is designed as a transparent area P1 and is located only in the pupil area S11, and the pixels in other areas are designed as normal pixels. In one embodiment, the camera 131 (sensing unit 13) can be fixed to the back surface S2 of the display unit 11 by using, for example, a fixing member, glue, or any of other fixing methods, wherein the fixing methods are not limited.

In another embodiment, as shown in FIG. 3C, when the camera 131 is an infrared camera, the display substrate 111 is an infrared permeable substrate, and the material includes, for example but is not limited to, glass, poly(methyl methacrylate) (PMMA), or polycarbonate. It can be understood that the pixels P in the penetration region A as shown in FIG. 3C can be normal pixels that can normally display images, and there is no need to specially configure the transparent area P1. In this case, the infrared camera can obtain black and white images for determination by the control circuit. In another embodiment, when the sensor is an infrared light detector or an infrared distance detector, the pixels P in the penetration region A can be normal pixels that normally display images, and no special design is required.

Unlike the aspect as shown in FIG. 3C, the penetration region A of the aspect as shown in FIG. 3D is a transparent area and is configured without any pixels P, the sensing unit 13 (camera 131) is disposed (fixed) on the back surface S2, and the top surface T of the camera 131 (sensing unit 13) faces the penetration region A. The reason of not configuring pixel P in the penetration region A is that when the simulated eyeball of the embodiment of the present disclosure is viewed from a certain distance (e.g. 1 meter away), because the dimension of the camera 131 is very small, even if the penetration region A is not configured with the pixel P, the camera 131 is still not easily visible and does not affect the realistic effect of the simulated eyeball. The design in which the pixel P is not provided in the penetration region A as shown in FIG. 3D can also be applied to FIG. 3B.

FIG. 4B is a functional block diagram of the realistic eyeball 1c as shown in FIG. 4A. The component configurations and connections of the realistic eyeball 1c of this embodiment of FIGS. 4A and 4B are mostly the same as those of the realistic eyeball 1a of the previous embodiment. Unlike the realistic eyeball 1a of the previous embodiment, in the realistic eyeball 1c of this embodiment, the sensing unit 13a further includes, in addition to the camera 131, a light detector 132. In this case, the camera 131 and the light detector 132 are both installed in the same through hole H, wherein the fixing method thereof is not limited. It can be understood that the light detector 132 of this embodiment can be replaced by a distance detector. In another case, an additional distance detector can be provided and installed next to the camera 131 and the light detector 132, and this disclosure is not limited thereto.

In addition, the realistic eyeball 1c can further include a control circuit board 18, which may be provided, for example, in the head portion or the body portion of the robot. The control circuit board 18 is electrically connected to the display unit 11 and the sensing unit 13. The control circuit board 18 is the main control board and may include a database 181. The database 181 may store a plurality of patterns and colors for the pupil area S11 and the iris area S12. Furthermore, the database 181 can also store a plurality of patterns and colors for the sclera area S13. In this embodiment, the patterns and/or color changes to be displayed (simulated) in the pupil area S11, the iris area S12 and the sclera area S13 vary according to different simulated animals, and can be inputted from the outside or stored in the database 181 of the control circuit board 18. The present disclosure is not limited thereto. For example, the patterns and colors of the pupil area S11, the iris area S12, and the sclera area S13 of human are different from the patterns and colors of the pupil area S11, the iris area S12, and the sclera area S13 of a cat or dog. Moreover, the patterns and colors of the pupil area S11, the iris area S12, and the sclera area S13 of different human races or different cats or dogs are different. These patterns and/or color changes can be stored in the database 181 in advance. When the control circuit board 18 knows what animal (including human) is selected for simulation, the corresponding patterns and colors of the pupil area S11, the iris area S12, and the sclera area S13 can be found in the database 181. Then, the display unit 11 can display the found patterns and colors of the pupil area S11, the iris area S12, and the sclera area S13 of the animal to be simulated.

In addition, the realistic eyeball 1c can further include a control unit 15, which can be electrically connected to the sensing unit 13a (camera 131, light detector 132) and the display unit 11 respectively through a flexible circuit board (e.g. COF). In this embodiment, the control unit 15 may be composed of software, hardware or firmware. The control unit 15 is disposed on the control circuit board 18. In another case, the control unit 15 can be disposed on an independent circuit board, and this disclosure is not limited thereto. The control unit 15 can change the displayed patterns and colors of the display unit 11 according to the sensing results of the sensing unit 13a (camera 131, light detector 132) (as well as the patterns and colors stored in the database 181). Moreover, the control unit 15 can further change the dimensions of the displayed patterns. In one embodiment, after the image of the pupil area S11, the iris area S12 and the sclera area S13 of the animal to be simulated can be obtained by, for example, the camera 131, the control unit 15 then controls the display unit 11 to display the corresponding pattern and color based on the images obtained by the camera 131. In another embodiment, as shown in FIG. 4B, the light detector 132 can sense the light passing through the convex lens unit 12 and the penetration region A and output a sensing signal CS, so that the control unit 15 can change the displayed patterns and colors of the pupil area S11 and the iris area S12 of the display unit 11 according to the sensing signal CS. For example, the control unit 15 can change the dimensions of the pupil area S11 and the iris area S12. In this case, when the dimension of the pupil area S11 decreases, the dimension of the iris area S12 increases, so that the sum of the areas of the pupil area S11 and the iris area S12 remains unchanged. In another case, when the dimension of the pupil area S11 increases, the dimension of the iris area S12 decreases.

For example, when the light detector 132 senses an external strong light, the control unit 15 can change the displayed pattern of the display unit 11. Specifically, the control unit 15 can control to decrease the dimension of the pupil area S11 and increase the dimension of the iris area S12. In another case, when the light detector 132 senses that the external environment is dark, the control unit 15 can increase the dimension of the pupil area S11 so as to increase the light entering the pupil area S11, and decrease the dimension of the iris area S12. This can simulate the real reaction of the eye to strong light or dark. In one embodiment, the light detector 132 may be a visible light detector or an infrared light detector, and this disclosure is not limited thereto.

In another embodiment, the sensing unit includes a distance detector. When the distance detector detects that the distance between an object and the realistic eyeball is less than a target distance, it can output a sensing signal, and the control unit 15 can adjust the distance between the realistic eyeball (the robot) and the object based on the sensing signal. For example, the control unit 15 can control to increase the distance between the realistic eyeball (the robot) and the object. In one embodiment, the light detector 132 or the distance detector is a micro-size detector. In one embodiment, the size of the light detector 132 or the distance detector may be, for example, 0.5 to 1.0 mm, but this disclosure is not limited thereto.

The component configurations and connections of the realistic eyeball 1d of this embodiment of FIG. 5 are mostly the same as those of the realistic eyeball 1a of the previous embodiment. Unlike the realistic eyeball 1a of the previous embodiment, in the realistic eyeball 1d of this embodiment, the display unit has a plurality of penetration regions A (e.g. two penetration regions A), and the penetration regions A are located in the pupil area S11 and the iris area S12. In addition, the sensing unit 13a also includes a plurality of sensors of different types (e.g. two different sensors), and the sensors of different types are respectively arranged in the transmission areas A. In this case, one penetration regions A (through hole H1) is disposed in the pupil area S11 and is configured with a camera 131. The other penetration regions A (through hole H1) is disposed in the iris area S12 and is configured with a light detector 132. In another embodiment, the plurality of penetration regions A may be all disposed in the pupil area S11 or all disposed in the iris area S12, and this disclosure is not limited thereto.

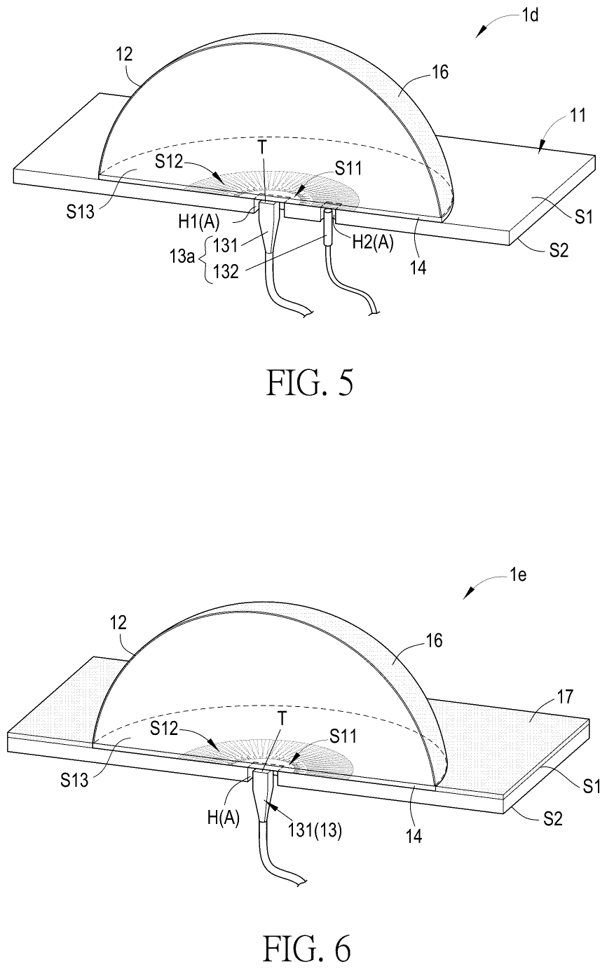

The component configurations and connections of the realistic eyeball 1e of this embodiment of FIG. 6 are mostly the same as those of the realistic eyeball 1a of the previous embodiment. Unlike the realistic eyeball 1a of the previous embodiment, the realistic eyeball 1e further includes a light-shielding layer 17, which is disposed on the display surface S1 and surrounds the sclera area S13. Accordingly, the light-shielding layer 17 can form a light-shielding area for preventing the light leakage at the outer edge of the sclera area S13.

To be understood, in the realistic eyeballs 1c, d and 1e of the above embodiments, the penetration region A is a physical hole (through hole), but this disclosure is not limited thereto. Those skilled in the art can apply the other features of the above embodiments to any other embodiment that the penetration region A is not a physical hole.

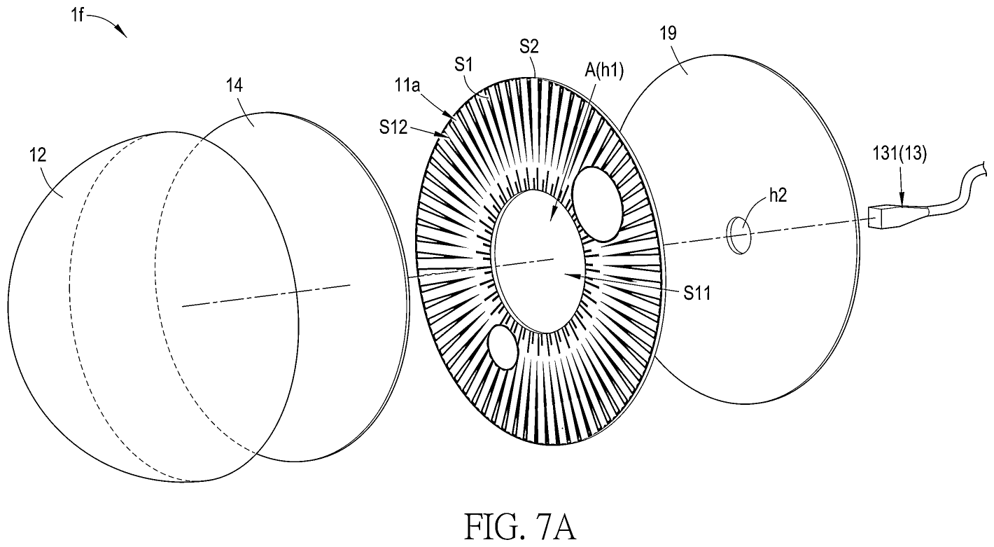

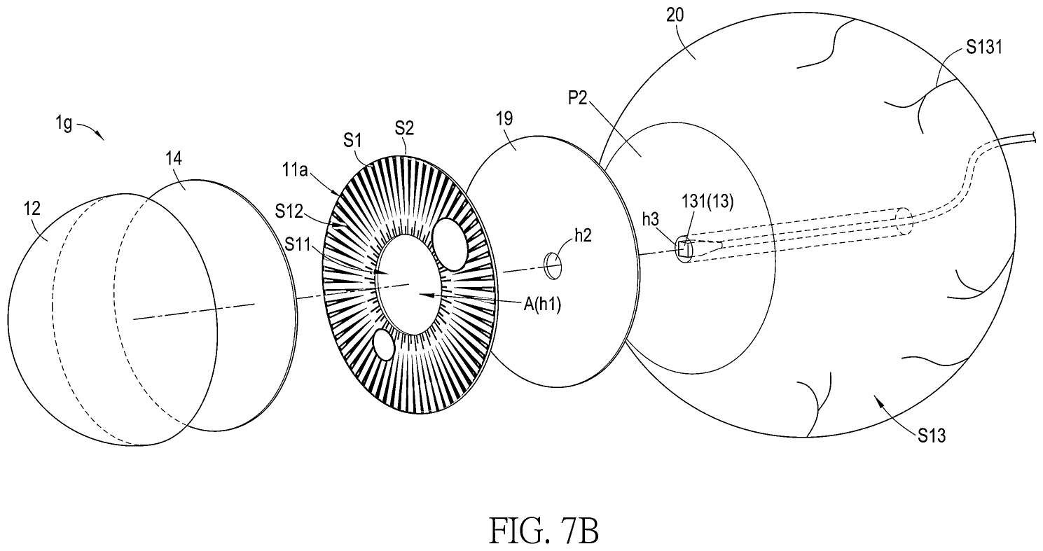

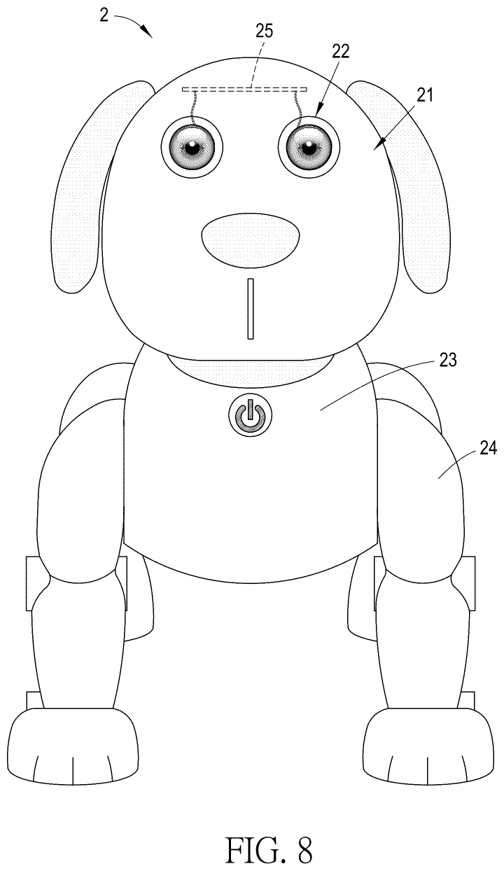

The component configurations and connections of the realistic eyeball 1f of this embodiment of FIG. 7A are mostly the same as those of the realistic eyeball 1 of the previous embodiment. Unlike the realistic eyeball 1 of the previous embodiment, the display unit 11a of the realistic eyeball 1f is a display device having a circular central hole. Specifically, the pupil area S11 of the display unit 11a is a circular first through hole h1 (the dimension of the pupil area S11 cannot be changed), so the display unit 11a can only display the iris pattern in the iris area S12. In addition, the realistic eyeball 1f of this embodiment further includes a light-shielding sheet 19. The light-shielding sheet 19 can be a black light-shielding sheet and has a second through hole h2 located corresponding to the first through hole h1 (pupil area S11). The dimension of the second through hole h2 is less than that of the first through hole h1. In this embodiment, the first through hole h1 is a penetration region A, and the sensing unit 13 (camera 131) is disposed in the first through hole h1 via the second through hole h2 (the fixing method thereof is not limited). In one embodiment, the display unit 11a and the light-shielding sheet 19 can be attached to each other through, for example, double-sided tape (not shown).

The component configurations and connections of the realistic eyeball 1g of this embodiment of FIG. 7B are mostly the same as those of the realistic eyeball 1f of the previous embodiment. Unlike the realistic eyeball 1f of the previous embodiment, the realistic eyeball 1g further includes a sphere body 20. The sphere body 20 can be a white plastic sphere body having a plane P2, and the dimension of the plane P2 is substantially equal to the dimension of each of the convex lens unit 12, the adhesive layer 14, the display unit 11a, and the light-shielding sheet 19. The convex lens unit 12, the adhesive layer 14, the display unit 11a, and the light-shielding sheet 19 are sequentially arranged on the plane P2 of the sphere body 20 by, for example, double-sided tapes. In addition, the sphere body 20 can further include a third through hole h3, which is located corresponding to the second through hole h2, so that the sensing unit 13 (camera 131) can be disposed in the first through hole h1 via the third through hole h3 and the second through hole h2. Moreover, the outer region of the plane P2 of the sphere body 20 can include a sclera area S13 configured to simulate the sclera of human eye, which can have a fixed displayed sclera pattern located at the periphery of the plane P2 (e.g. the red lines (blood vessels) S131).

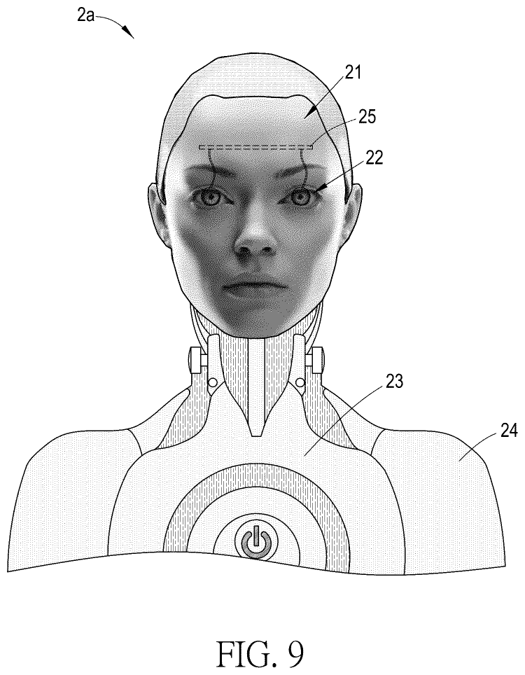

FIGS. 8 to 10 are schematic diagrams showing a robot according to different embodiments of this disclosure.

Referring to FIG. 8, a robot 2 includes a head portion 21 and at least one realistic eyeball 22, and the realistic eyeball 22 is arranged on the head portion 21. In this embodiment, the robot 2 includes, for example, two realistic eyeball 22 arranged on the head portion 21. The realistic eyeball 22 can be selected from any one of the above-mentioned realistic eyeballs 1 and 1a to 1g, or any modifications thereof. The specific technical contents of the realistic eyeball 22 have been described in the above embodiments and will not be described further here.

In this embodiment, the robot 2 further includes a body portion 23, four limbs 24 and a control circuit board 25. The control circuit board 25 can be the aforementioned control circuit board 18 (including the database 181) as shown in FIG. 4B, and is installed in the head portion 21. The robot 2 can change the patterns and colors of the pupil area, the iris area and the sclera area by the control circuit board 25 according to the owner or autonomous control. This disclosure is not limited thereto. In this case, the robot 2 simulates a terrestrial animal such as, for example but not limited to, a pet robot (robot dog). In different embodiments, the robot 2 can be any of other terrestrial animals (e.g. a robot cat, a robot bird, a robot pig, or the like), any of aquatic animals (e.g. a robot fish, a robot dolphin, or the like), or a service robot, and this disclosure is not limited thereto.

In one application example, the pet robot is a robot dog. Because most pet dogs have shorter lifespans than humans, the owner can store the information about the patterns and colors of the robot dog's eyeballs (including the pupil areas, iris areas and sclera areas) in advance while the dog is still alive. When the dog passes away, the stored information can be used to setup the realistic eyeballs, which are then applied to the pet robot (robot dog). When the owner sees the pet robot's expression and eyes, it seems that the dog is still alive.

In addition, the component configurations and connections of the robot 2a of this embodiment of FIG. 9 are mostly the same as those of the robot 2 of the previous embodiment. Unlike the robot 2 of the previous embodiment, the robot 2a is a service robot. The service robot 2a is also installed with the realistic eyeballs 22, and the patterns and colors of the display unit (including the pupil areas, the iris areas and the sclera areas) of the realistic eyeballs 22 can be changed by the control circuit board 25 according to the owner or autonomous control, thereby simulating the patterns and/or color changes of human eyes to express emotions. For example, the pupil may constrict when exposed to strong light, the sclera area may have obvious red lines (blood vessels) when working for a long time or rubbing the eyes, or the eyes may tear when encountering sad situations, etc.

In some application examples, the aforementioned robot 2 or 2a can enable the control circuit board 25 to control the display unit of the realistic eyeballs 22 to generate a warning function according to a scenario. The warning function may include, for example, flashing or/and displaying a fault code. For example, when the robot acknowledges (from the Internet or from its own camera detection) that there is a fire alarm in the building where it is located, it can actively control the display unit of the realistic eyeballs 22 to generate, for example, a red or green light flash (may also display the warning codes). Moreover, if the robot is equipped with a speaker, it can also output a voice reminder. When the robot detects that its battery power is lower than a threshold value, it can actively control the display unit of the realistic eyeballs 22 to generate, for example, a red or yellow light flash (may also display the warning codes). Moreover, if the robot is equipped with a speaker, it can also output a voice reminder. When the robot detects a malfunction in its own mechanism, it can actively control the display unit of the realistic eyeballs 22 to generate a code (e.g. an error code, and may also flash). If the robot is equipped with a speaker, it can also output a voice reminder to notify and assist the maintenance personnel to perform maintenance. The aforementioned scenarios including fire alarm, low battery and mechanical malfunction are only examples and are not used to limit the present disclosure.

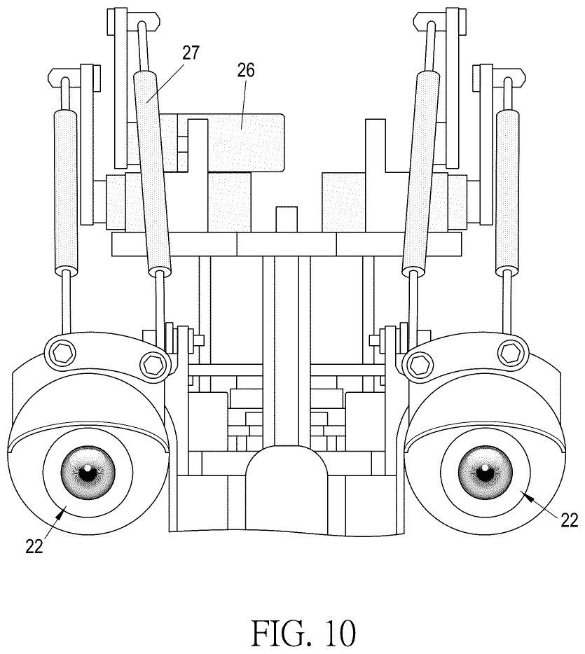

As shown in FIG. 10, a linking mechanism can be provided in the head portion of the robot to control the rotation of the realistic eyeballs 22. For example, a plurality of actuators 26 are provided, and the actuators 26 are connected to the two realistic eyeballs 22 through a plurality of connecting rods 27. Accordingly, the actuators 26 and the connecting rods 27 can control the rotation of the realistic eyeballs 22.

In summary, in the realistic eyeball and the robot with the realistic eyeball of this disclosure, the display surface includes a pupil area and an iris area surrounding the pupil area, the pupil area or the iris area has at least one penetration region, the convex lens unit is disposed on the display surface and covers the pupil area and the iris area, the sensing unit is disposed at the display unit and located corresponding to the penetration region, and the pupil area and the iris area have different patterns and colors according to different simulated animals. Based on this design, the realistic eyeball can simulate the patterns and/or color changes presented by the eyes of different human races or animals. In addition, the realistic eyeball of the present disclosure can realistically resemble the eyes of humans or any of other animals, thereby presenting the eyes with patterns and/or color changes that are unique to individual or specific animal, and can also express emotions through the displayed patterns.

Moreover, in one embodiment, the sensing unit may include a camera, which can receive the external light passing through the convex lens unit and the penetration region, and then see (detect) the object in front of the realistic eyeball, so that the robot can perform corresponding actions accordingly. In another embodiment, the sensing unit may include a light detector, and the light detector may detect the light passing through the convex lens unit and the penetration region. Then, the display unit can change the dimensions of the pupil area and the iris area. In another embodiment, the sensing unit may include a distance detector, and the distance detector may detect the distance between the realistic eyeball (robot) and an object, thereby adjusting the distance between the object and the realistic eyeball according to the detected distance.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A realistic eyeball, comprising:
a display unit having a display surface, wherein the display surface comprises a pupil area and an iris area surrounding the pupil area, and at least one of the pupil area and the iris area has at least one penetration region;
a convex lens unit disposed on the display surface and covering the pupil area and the iris area; and
a sensing unit disposed at the display unit and located corresponding to a position of the at least one penetration region;
wherein, the pupil area and the iris area have different patterns and colors according to different simulated animals.

2. The realistic eyeball of claim 1, wherein the penetration region is configured with a through hole, the sensing unit is arranged in the through hole, and a top surface of the sensing unit faces an opening of the through hole.

3. The realistic eyeball of claim 1, wherein the penetration region is configured with a plurality of pixels, the display unit further comprises a back surface opposite to the display surface, the sensing unit is disposed on the back surface, and a top surface of the sensing unit faces the penetration region.

4. The realistic eyeball of claim 3, wherein a part of each of the pixels in the penetration region is a transparent area, and the transparent areas define the penetration region.

5. The realistic eyeball of claim 1, wherein the penetration region is a transparent area and is configured without any pixel, the display unit further comprises a back surface opposite to the display surface, the sensing unit is disposed on the back surface, and a top surface of the sensing unit faces the penetration region.

6. The realistic eyeball of claim 1, wherein the sensing unit comprises a sensor, and the sensor comprises a visible-light sensor, an infrared sensor, or an ultrasonic sensor, or a combination thereof.

7. The realistic eyeball of claim 6, wherein the sensor comprises a camera, a light detector, or a distance detector, or a combination thereof.

8. The realistic eyeball of claim 1, wherein the display unit comprises a display substrate, the display substrate has a plurality of pixels, and when the sensing unit comprises an infrared sensor, the display substrate is permeable by an infrared light.

9. The realistic eyeball of claim 1, further comprising:
a control unit electrically connected to the sensing unit and the display unit;
wherein, the sensing unit comprises a light sensor, the light sensor receives a light passing through the convex lens unit and the penetration region and outputs a sensing signal, and the control unit changes a dimension of the pupil area and a dimension of the iris area of the display unit based on the sensing signal.

10. The realistic eyeball of claim 1, wherein at least one of the pupil area and the iris area has a plurality of the penetration regions, the sensing unit comprises sensors of different types, and the sensors of different types are arranged in the penetration regions, respectively.

11. The realistic eyeball of claim 10, wherein the penetration regions are distributed in the pupil area and the iris area.

12. The realistic eyeball of claim 1, wherein the display surface further comprises a sclera area surrounding the iris area, the convex lens unit further covers the sclera area, and each of the pupil area, the iris area and the sclera area displays one of the patterns and one of the colors.

13. The realistic eyeball of claim 12, further comprising:
a light-shielding layer disposed on the display surface and surrounding the sclera area.

14. The realistic eyeball of claim 1, further comprising:
a control circuit board electrically connected to the display unit and the sensing unit, wherein the control circuit board comprises a database, and the database stores a plurality of the patterns and colors of the pupil area and the iris area.

15. The realistic eyeball of claim 1, further comprising:
a functional layer disposed on a surface of the convex lens unit away from the display unit.

16. The realistic eyeball of claim 1, further comprising:
a light-shielding sheet, wherein the pupil area of the display unit is a first through hole, the display unit further comprises a back surface opposite to the display surface, the light-shielding sheet is disposed on the back surface and has a second through hole corresponding to the first through hole, a dimension of the second through hole is less than a dimension of the first through hole, and the sensing unit is disposed in the first through hole via the second through hole.

17. The realistic eyeball of claim 16, further comprising:
a sphere body having a plane, wherein the convex lens unit, the display unit and the light-shielding sheet are arranged on the plane, and the sphere body has a sclera pattern located at a periphery of the plane.

18. A robot, comprising:
a head portion; and
a realistic eyeball disposed on the head portion, wherein the realistic eyeball comprises a display unit, a convex lens unit, and a sensing unit, the display unit has a display surface, the display surface comprises a pupil area and an iris area surrounding the pupil area, at least one of the pupil area and the iris area has at least one penetration region, the convex lens unit is disposed on the display surface and covers the pupil area and the iris area, and the sensing unit is disposed at the display unit and located corresponding to a position of the at least one penetration region;
wherein, the pupil area and the iris area have different patterns and colors according to different simulated animals.

19. The robot of claim 18, wherein the robot is a service robot or a pet robot.

20. The robot of claim 18, wherein the robot controls the display unit to flash and/or to display a code based on a scenario.
